(19) United States
(12) Patent Application Publication
(10) Pub. No.: US 2004/0022058 A1
(43) Pub. Date: Feb. 5, 2004

(54) Lighting system

(75) Inventor: Peter Charles Birrell, Avalon NSW (AU)

Correspondence Address: WILDMAN, HARROLD, ALLEN & DIXON, 225 WEST WACKER DRIVE, CHICAGO, IL, 60606, US

(73) Assignee: FLAT WHITE LIGHTING PTY LTD., Avalon NSW 2107 (AU)

(21) Appl. No.: 10/399,102

(22) PCT Filed: Oct. 12, 2001
(86) PCT No.: PCT/AU01/01289

(30) Foreign Application Priority Data
Oct. 13, 2000 (AU) PR 0757
Dec. 13, 2000 (AU) PR 2071

(51) Int. Cl. F21V 21/00

(52) U.S. Cl. 362/249

(57) ABSTRACT

A system 10 is disclosed for connecting an electrical device such as a lighting element 50 to a power source 11. The electrical device includes electrical couplings 55, 56 in the form of metallised strips which are operative to form a capacitive coupling with respective conductive elements 24 disposed in an array on a supporting surface. The conductive element 24 on the supporting surface are connected to the power supply. In the preferred form, the electrical device is in the form of a light tile which includes embedded LEDs 59 and control and sensing devices (60, 61) which are able to receive and transmit data via the signal path used by the power source. The lighting tile 50 is operative to be secured to the supporting surface via a magnetic force so that the tile may be simply and easily fixed to and removed from the supporting surface.

The present invention relates generally to systems and methods for connecting electrical devices to power sources. The invention has been designed especially but not exclusively for, lighting systems to illuminate wide areas, and the invention is herein described in this context. However, it is to be appreciated that the invention has broader application and may be used in conjunction with other electrical devices or other lighting arrangements such as those used in information displays, signage, feature lighting, decorative lighting or advertising lighting or the like.

Several problems exist when implementing a lighting system using currently available lighting elements. Flush mounting requires a co-operating surface behind which the light fittings may be mounted. This surface will thus encroach into the room space and render a portion of the volume of the room space unusable. Further, the location, size and quantity of the light fittings and controls must be decided to suit the perceived or present needs. If these needs change then it is difficult to change the locations, size or quantity of the light fittings or controls, due to the fixed wiring and physical mounting requirements of each device. If a change is made then the supporting structure would most likely require structural and surface repair to remove evidence of a change to the lighting system.

An aim of the present invention is to ameliorate the above problems by providing an improved system for connecting electrical devices to a power source. The invention is ideally suited to lighting systems and may enable that lighting system to have the functionality and aesthetics of a currently available lighting element but exhibit enhanced flexibility for installation and control.

In a first aspect, the present invention relates to a system for connecting an electrical device to a power source, the system providing for an electrical coupling between the electrical device and an energised surface associated with the power source and comprising:

at least two conductive elements disposed at or adjacent an exterior surface of the electrical device, and

a supporting surface including an array of conductive elements connectable to the power source to form the energised surface,

wherein the array of conductive elements and the supporting surface are arranged such that, when the electrical device is contacted with the energised surface in any one of a plurality of selected positions, the conductive elements of the electrical device make a capacitive coupling with some of the conductive elements located on the supporting surface so as to couple capacitively the electrical device to the power source.

A particular advantage of this arrangement is that the device may be coupled to the power source without requiring any direct connection between the respective conductive elements of the device and the supporting surface. As a result the connection may be made without any physical damage to the supporting surface. A further advantage of this form is that the capacitive coupling provides a non-dissipative current limiting element for the device. Also the device may be hermetically sealed without exposed conductive elements that may oxidise or pose a hazard.

In the context of the specification, the electrical device relates to electrical appliances and apparatus that in the past were usually required to be connected to a power source by fixed wiring. The advantage of the present invention is that the electrical device is able to be disposed on the supporting surface to provide the electrical connection with the power source. As such the need to provide any significant structural changes to the supporting surface in installation of the device is obviated.

The electrical device preferably is a lighting element. In a second aspect the present invention relates to a lighting system including a lighting element and a support structure, the lighting element comprising a generally thin body having opposite first and second major surfaces, at least one lighting source mounted to the body and operative to emit light, and at least two conductive elements disposed at or adjacent to the second major surface, the supporting surface including an array of electrically conductive elements which are connectable to a power source so as to provide an energised surface, wherein the lighting element is able to be disposed in any one of a plurality of selected positions on the energised surface where at least two of the conductive elements of the supporting surface form a capacitive coupling with the at least two conductive elements of the lighting element so as to connect the lighting element to the power source.

The system is ideally suited to a broad range of electrical devices including lighting systems, entertainment systems, security systems, sensors and other control devices.

In situations where the lighting element is suitable for use in wide area lighting, the supporting surface is typically a wall or ceiling. However the invention is not limited to this application and may be used in other decorative, feature or advertising situations. For example, the supporting surface may be an advertising display, or a piece of furniture such as a table surface where the lighting element is used for a particular purpose (such as reading) or as a feature.

When the electrical device or the lighting element is mounted on the supporting surface, the at least two electrically conductive element of the electrical device or the lighting element are brought into close and substantially parallel relationship to the electrically conductive elements of the supporting surface. To provide the desired capacitive coupling, an electrically insulating layer needs to be disposed between the electrically conductive elements of the supporting surface and the or each electrically conductive element of the electrical device or the lighting element. This may be achieved by an insulating overlay on either the electrical device (or the lighting element), or on the supporting surface or on both.

In one form, the array of electrically conductive elements of the supporting surface are mounted on a backing sheet which forms the first electrically insulating layer. The sheet may also include the second electrically insulating layer. This sheet may be produced in continuous lengths and be secured to said supporting structure as a surface coating in a similar fashion to wallpaper. Suitable materials here are metallised polymer or metallised paper without backing, with a flexible backing sheet of polymer, paper, rubber or silicone or with a rigid backing insulator such as plasterboard.

In another form, the array of electrically conductive elements of the supporting surface are mounted on a rigid backing material such as plasterboard. A second electrically insulating layer may then be included. The advantage of this form is that only one process is needed to fix both the plasterboard and the electrical elements and insulator as the integral means for capacitively coupling the device or the lighting element.

In one form, the second insulating layer on the supporting surface may include or be comprised of the surface finish suitable for the area. This may be a typical paint finish. An advantage of this form is that the energised electrically conductive plates and insulators are invisible and undetectable to the users of the space behind the painted surface. A further advantage of this form is that the surface finish itself can contribute to the improved efficiency of the power transfer across the capacitive coupling by including a high dielectric constant material such as titanium dioxide.

In the case where there are more than two electrically conductive elements on the electrical device or the lighting element (eg. 4, 6, 8 etc. adjacent conductive strips or diametrically opposed conductive strips) these are suitably interconnected by circuit elements on the device or the element so that capacitive coupling to a power source requires a progressively lower degree of lateral or angular precision when positioning the lighting element onto the supporting surface. An advantage of this is that a lower level of skill is then required to install the device onto the supporting structure surface to achieve a higher level of positioning accuracy.

The electrical device or the lighting element may be secured to the supporting surface in any suitable manner such by mechanical fasteners or through an adhesive or the like. However, in a preferred form, the device or the element is affixed adjacent to the supporting structure by a permanent magnetic force. The magnetic force is exerted between a magnetisable material located on or in the supporting surface and a magnetisable material located on or in the body of the device.

The electrically conductive elements on both the supporting surface and the electrical device or the lighting element may be a material that is not ferromagnetic, so as not to attenuate the magnetic force exerted between the device and the supporting surface. Alternatively the electrically conductive elements on either the supporting surface of the electrical device or the lighting element may be both conductive and ferromagnetic thereby integrating both the functions of conduction for electrical power coupling and magnetic receptor for affixing.

Suitable materials for use as active permanent magnets are ferrous oxide based flexible magnetic sheet, ferrite, alnico or rare earth permanent magnets. Magnetisable material may already be included in the supporting surface such as reinforcing bar in concrete structures. Suitable materials that are any ferromagnetic material.

In a further preferred form, the electrical device or the lighting element consists of or includes integrally embedded electronic manual controls such as touch switches or light level controls, remote controls such as radio frequency or infra-red, automatic controls such as clock timers or automatic light level controls or sensors such as occupancy, ambient light, temperature, smoke, proximity or other human or environmental sensors, or a combination of any of these controls and sensors. Data communication between devices or elements including controls or sensors and devices or elements without controls or sensors may be achieved by means of wireless techniques such as radio frequency, infra-red or direct connection such as modulation of the external power source used by the device. In this way, devices (or elements) including controls or sensors can serve to control other devices (or elements) without controls or sensors, thus eliminating the need for other wired control or sensing elements. Another advantage is that devices or elements can be individually addressed in a networked data environment without the constraints of fixed wiring. A further advantage is that the same external power source connection can be used by devices or elements including controls or sensors as may be used by those without controls or sensors.

The arrangement of being able to provide both data and power through the electrical coupling may have broad application, particularly in enabling coordinated control of separate electrical devices. This can be particularly applicable for centralised control of electrical devices within a residential property. For example, entertainment or information display systems, such as televisions, computer monitors, DVD players, CD players, radio receivers and audio speakers may be connected to the energised surface so that their power and control functionality is coordinated through the electrical coupling to thereby enable them to be networked with the other devices which are similarly connected. In this arrangement, control data may be transferred by the energised surface, whereas information data may be transferred using other known techniques such as infrared or radio frequency.

As indicated above, the system is ideally suited for use as part of a lighting system and in a further aspect, the present invention provides a lighting element suitable for connection to a power source using the system above-defined for connecting an electrical device to a power source. The lighting element comprises a body having opposite first and second major surfaces, at least one light source mounted to the body to emit light and at least two conductive elements disposed at or adjacent to one of the surfaces arranged to form a capacitive coupling with an energised surface.

In a particularly preferred form, the light source is embedded within the element body between the opposite major surfaces. This arrangement is ideally suited for mounting on surfaces such as walls, windows or ceilings where it can be installed without requiring a recessed cavity to house components of the lighting source. As such, the element can significantly reduce the amount of space required to mount the lighting elements.

The body of the lighting element may be provided in different sizes and shapes and may also be rigid or flexible. In one form, the body of the lighting element may be in the form of a sheet like material of indefinite length whereas in another form the body may be more compact and formed in the shape of a tile or the like. Further, the body may be of a unitary structure or may include a combination of materials in a laminated or other arrangement. The body may also be solid or incorporate voids or passages. In one form the body displays even light diffusion characteristics. In another form, the body may be constructed to display uneven light diffusion or focussed characteristics to produce a range of lighting effects.

Preferably the body includes a layer in which the light source is embedded or to which the light source is attached. Suitable materials for this layer include transparent, translucent, white or colour tinted polymers such as polycarbonate, transparent, translucent, white or colour tinted silicone, transparent, translucent, white or colour tinted fused material such as glass or a combination of polymer, fused material and silicone.

In one form, the at least one light source is an LED. These typically have a life of around 100,000 hours. An LED light source or sources may be embedded directly into the body of the lighting element utilising intrinsic material thermal conductivity for thermal management.

Other suitable light sources include resonant cavity, single mode or electronically powered photon recycling light-emitting diodes (LEDs) and LEDs other than compound semi-conductor LEDs such as organic polymer LED materials. In addition, cold cathode fluorescent or electroluminescent light sources may also be suitable.

In a one form, the at least one light source is a white LED. These operate by action of a mono-chromatic blue semi-conductor LED light activating a phosphor coating or layer. The phosphor coating or layer converts mono-chromatic light with a wavelength of blue light or shorter to substantially white light containing light of various wavelengths. However, LEDs of any available colour may be utilised as required.

The phosphor coating may be directly applied on to the LED. In an alternative form, the lighting element includes a phosphor layer disposed at or adjacent to the first major surface of the lighting element. In this way a lighting element including blue LEDs may emit substantially white light. An advantage of performing the conversion at or adjacent to the first major surface is that the optical properties of the lighting element as a source of white light are improved over an arrangement where the phosphor coating is applied to the or each LED.

In a particularly preferred form, the body includes a layer of translucent material laminated with at least one electrically conductive layer. The at least one electrically conductive layer may facilitate electrical connections within the lighting element and may also provide the lighting element with additional mechanical strength.

The at least one electrically conductive layer may provide a planar optical reflector. The surface characteristics of said at least one electrically conductive layer may be optimised for uniform optical reflection to provide a uniform diffused light source. Alternatively the at least one electrically conductive layer may be generally transparent to allow other light sources to be seen through the lighting element.

In a particularly preferred form, the at least one light source is positioned within the body. In the case of utilising more than one light source in a lighting element, these may be spaced within the body. However, the at least one light source may be positioned on any edge surface. Various applied optical methods may be employed within the body to produce even diffused light output, focussed or directional light output as required.

The lighting element according to this aspect of the invention is ideally suited for use in the system described above. In particular the lighting element may be designed to be capacitively coupled to the power source using the techniques mentioned above and may include a magnetisable layer so as to be able to be secured to the supporting surface by receptive force.

A preferred form of the present invention provides a lighting system wherein a thin and generally planar lighting element may be releasably affixed to a surface, such as a wall, and powered via capacitive coupling formed between electrically conductive elements positioned on the back of the lighting element and on the surface to which the lighting element is attached. Further, the lighting elements may be controlled by data transmitted with the power supply.

It is convenient to hereinafter describe embodiments of the present invention with reference to the accompanying drawings. It is to be appreciated that the particularity of the drawings and the related description is to be understood as not superseding the generality of the preceding broad description of the invention.

In the drawings:

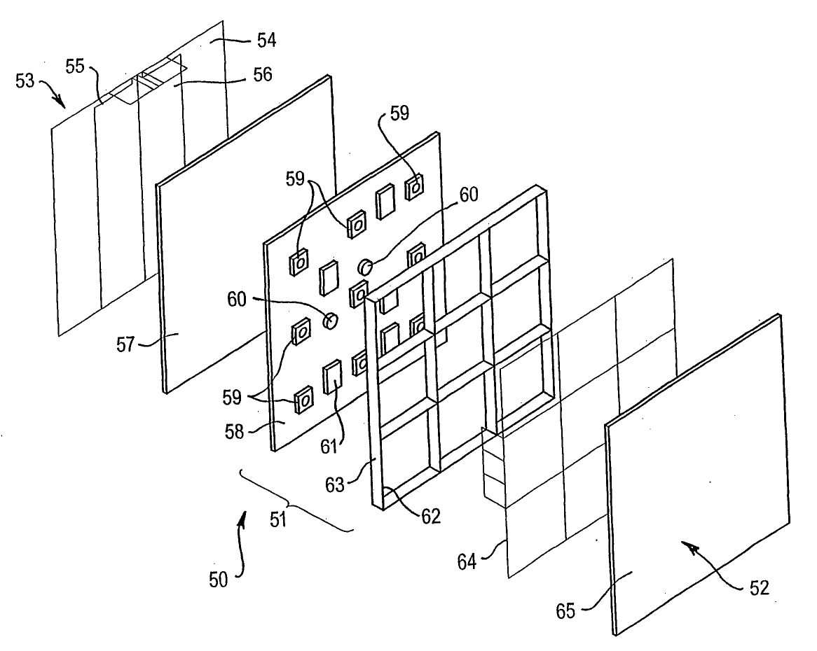

FIG. 1 is an exploded view of a light tile for use in the lighting system according to an embodiment of the invention;

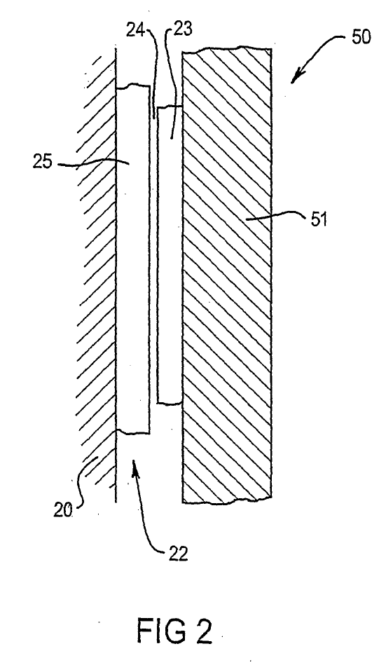

FIG. 2 is a side elevation showing the lighting tile of FIG. 1 mounted on a support structure of the lighting system;

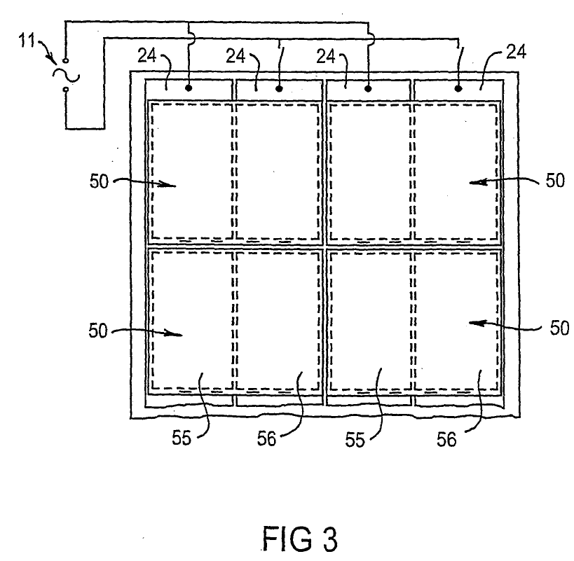

FIG. 3 is a front elevation in schematic view illustrating four of the lighting tiles of FIG. 1 mounted on the surface and connected to a power source;

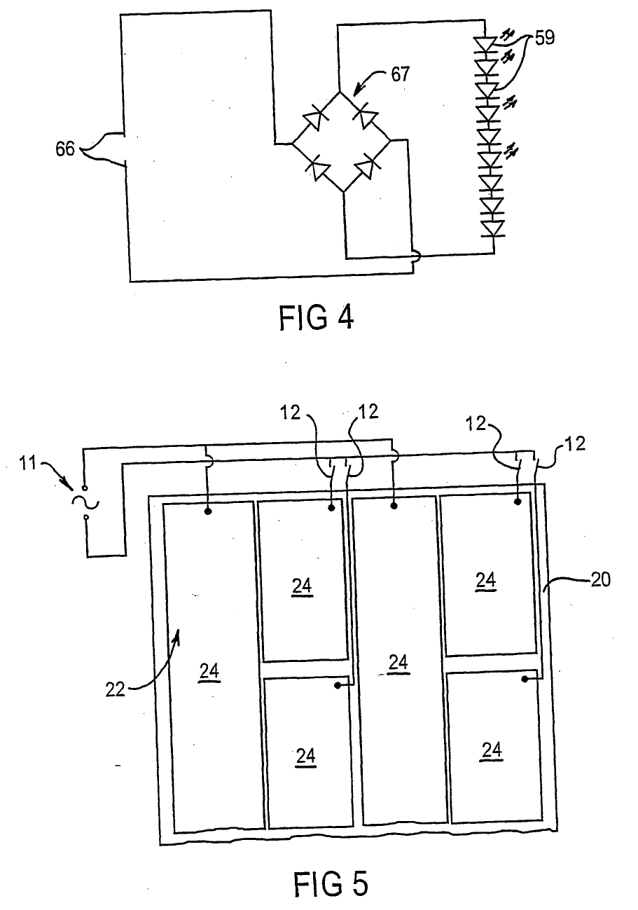

FIG. 4 is a simplified circuit diagram of the circuit illustrated in FIG. 3;

FIG. 5 is a schematic view of an alternate circuit arrangement of the support structure of the lighting system of FIG. 2;

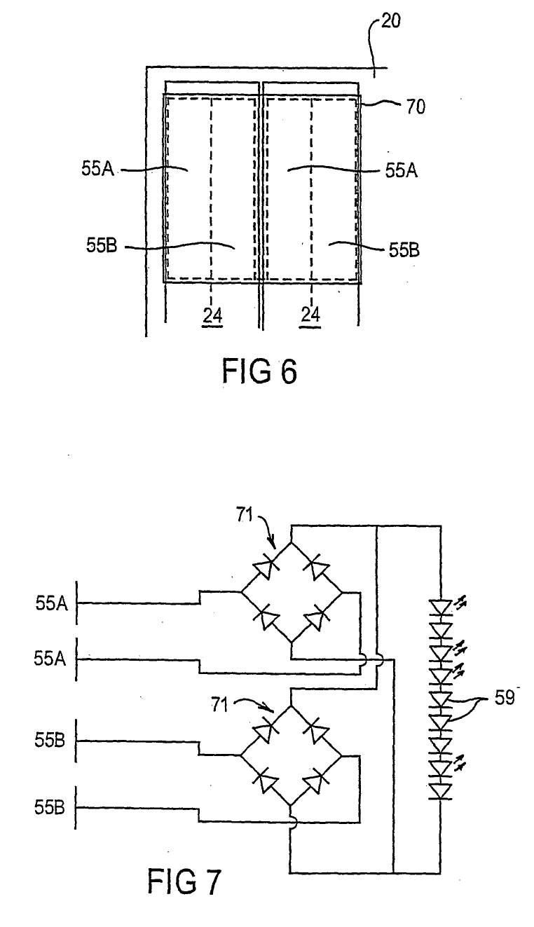

FIG. 6 is a schematic view of the lighting system using an alternative lighting tile to that disclosed in FIG. 1;

FIG. 7 is a simplified circuit diagram of the lighting system of FIG. 6;

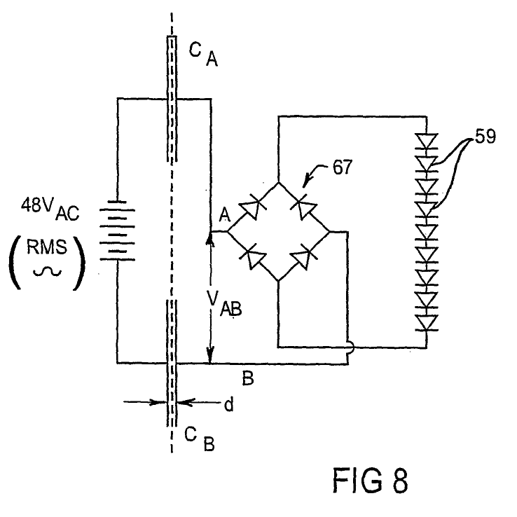

FIG. 8 is a more detailed circuit diagram;

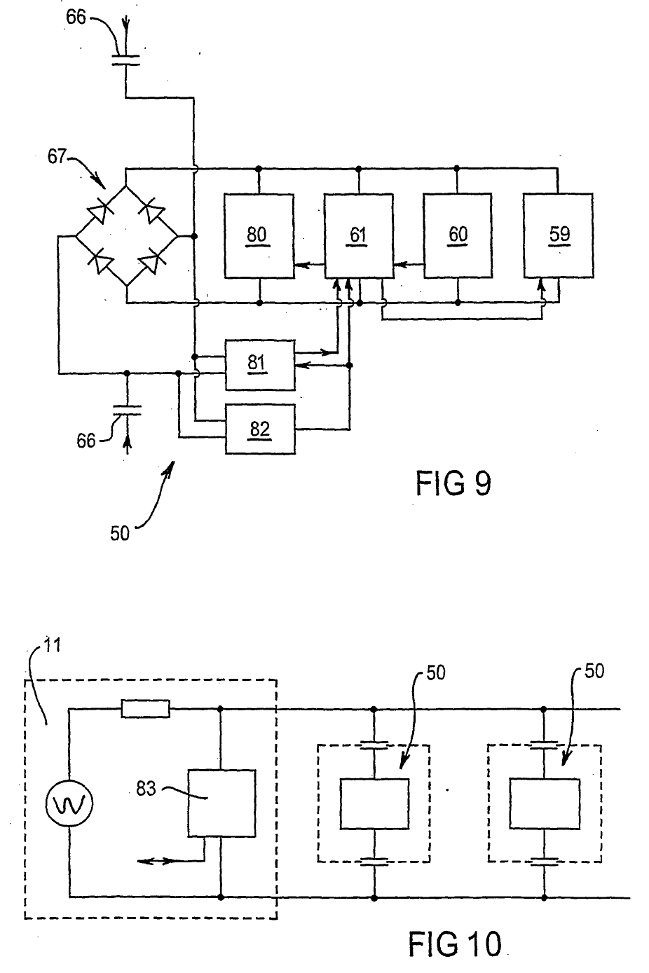

FIG. 9 is a block diagram of the lighting tile circuitry including sensor and control functions; and

FIG. 10 is a block diagram of the network of the lighting system.

FIG. 1 illustrates in exploded view, a lighting tile 50 for use in a wide area lighting system 10. The lighting tile 50 has a thin body 51 having opposite first and second major surfaces (52, 53). The body 51 is of layered structure made of six main components.

The rear most component 54 has an outer surface which forms the second major surface or back face 53 of the body 51. This component is made from a polymer film which includes metallised strips 55, 56 disposed on an inner side thereof. The metallised strip 55, 56 act as electrical coupling elements for the tile 50 to enable it to be capacitively coupled to a power source as will be described in more detail below. The polymer film forms an insulating layer over the metallised strips 55 and 56 thereby fully securing the electrical coupling elements within the tile body 51.

The next layer of the tile body 51 is a flexible magnetic sheet 57 which provides an active magnetic force to secure the lighting tile to an appropriate magnetic receptive element. As will be described in more detail below, the use of a magnetic force to mount the tile to a supporting structure is ideally suited to the lighting system 10 as it provides a convenient system whereby the tile 50 may be secured and removed from a supporting structure which incorporates an appropriate magnetic receptor without damage to that supporting structure.

The next layer of the tile body includes a printed circuit board subassembly 58 which provides the mechanical support for circuitry and the electrical components to provide the various functions of the lighting tile 50. In the illustrated form, mounted on the circuit board 0.58 includes nine LEDs 59 which are set out in a 3×3 grid format. Sensors 60 are also disposed on the circuit board 58. The exact nature of the sensors may vary depending on the required functionality of the lighting tile 50. The sensors may include, but not limited to, any one or combinations of the following: pyroelectric sensors, long wave length infrared sensors, microwave proximity sensors, ultrasonic proximity sensors, infra-red short wave detectors for remote control, photosensors for visible light level detections, temperature sensors, humidity sensors, air pressure sensors, smoke detectors, RF transmitter or receiver modules, microphone, video image capture, infra-red image capture, and touch sensor conditioning electronics.

Also mounted on the circuit board, is at least one microcontroller 61 to control the various light tile functions. This controller 61 typically controls the total amount of energy available to all the LEDs and is able to control individual LED brightness, to accept signals from sensors to convert to a local or remote report or command, and to construct and transmit data messages for remote reporting or command. The controller may also be structured to interpret and act upon received data reports or commands. The circuit board 58 also includes data circuits to modulate and demodulate signal as well as to recover the data clock signal. Also power supply circuitry is incorporated such as bridge rectifiers and energy storage components.

The next adjacent layer of the lighting tile is a supporting frame 62 which locates over these components mounted on the circuit board to thereby provide some physical protection to those components. Typically, the frame is made from an injected moulded polycarbonate but other suitable materials may be used. The frame 62 may also provide the external edge 63 to the light tile body.

The next layer is a further metallised polymer film 64 which acts as a touch sensor to enable the lighting tile 50 to be controlled, to at least some extent by human touch on the first major surface 52 of the tile body. In the illustrated form, the selective metallised polymer film 64 provides lines of horizontal and vertical fine metallisation on a clear polymer film. In this way it acts as a high impedance capacitive pick up for human touch sensing.

The final component of the tile body 51 is a front cover which provides an optical correction for emitting light using defusion, defraction, focussing or other applied optical techniques. The front cover may also provide a long wave length infra-red fresnel lens embossing to improve or to rationalise a pyroelectric sensor field of view if required. Further, the front cover may provide optical lenses for incoming video or infra-red image capture again depending on the required functionality of the lighting tile 50.

The lighting system 10 is designed so that the lighting tile 50 is to be mounted to a supporting structure 20 and coupled to a power supply 11 by a capacitive coupling arrangement.

With reference to FIGS. 2 and 3, the supporting structure is illustrated as a wall and includes an outer surface overlay 22 which is specifically to provide one part of the capacitive coupling and also to enable the lighting element 50 to be mounted to the wall 20 by a magnetic force generated by the magnetic sheet 57.

The surface overlay 22 is best illustrated in FIG. 2. It is to be appreciated that the coatings are not drawn to scale so as to more easily represent the main component features. The surface overlay 22 is a laminated structure which is applied to the wall 20. The surface overlay 22 includes an outer polymer film 23 which includes metallised strips 24 and a magnetic receptive layer 25. The surface overlay 22 is constructed so that the metallised strip 24 are located intermediate the polymer film 23 and the magnetic receptive layer, each of which provide insulating layers for the metal strip.

In a similar arrangement to that disclosed in respect of the lighting tile 50, the metallised strips act as electrical coupling elements which form part of the capacitive coupling arrangement of the lighting system 10. In particular, as best illustrated in FIG. 3, each of the metallised strips is connected to the power supply 11 which in the illustrated embodiment is a 48 Volt AC power supply.

As indicated above, the surface coating 22 is designed to be applied to the supporting structure 20. In use, the surface coating can be provided over a wide area of the supporting structure 20 and may be fixed to a supporting structure in one step in a similar manner to hanging wallpaper. As a 48 Volt AC power supply is used, the system does not present an electric shock hazard to persons or animals.

In use, the lighting tile 50 is placed against the surface overlay 22 of the support structure with the second major surface 53 of the tile facing towards the support structure 20. In view of the proximity of the magnetic sheet 57 to the magnetic receptive layer 25 of the surface overlay 22, the tile can be secured in place solely by the magnetic force, Further, the tile is positioned on the supportive structure 20 so that the metallised strips 55, 56 are aligned with pairs of the metallised strips 24 formed on the surface coating. When mounted in this manner, capacitors 66 are formed between the aligned pairs of strips which serve to couple the lighting elements to the power supply.

Referring to FIG. 4, a simplified circuit diagram for a lighting tile 50 in the lighting system 10. The nine LEDs 59, are shown connected to diodes 67 located on the circuit board 58. The diodes are configured to form a bridge rectifier. This configuration ensures that light is emitted from the LEDs during both the positive and negative cycles of the AC power supply coupled via capacitors connections 66. Not shown in this circuit diagram are other circuit elements that may be used to control any or all of the LEDs and other circuit elements that may be used to perform any of the previously mentioned control or sensing functions.

In the embodiment illustrated in FIG. 3, switches 12 may be incorporated in the electric circuit to enable specific areas of the array to be selectively activated to thereby control operation of the lighting tile 50 mounted thereto. In an alternate arrangement illustrated in FIG. 5, some of the metallised strips 24 in the surface coating 20 are discontinuous with those discontinuous portions being independently connected to the power supply 11. Each of these connections may also include switches 12 to enable more selective activation of areas of the supporting structure. When the lighting elements include the control functionality as discussed in more detail below, the need for switches is obviated.

Whilst not shown, the surface coating may also include a typical paint finish so that the energised surfaces are not readily distinguished from a normal wall. A further advantage of a surface finish such as paint is that it in itself can contribute to the efficiency of the power transferred across the capacitive coupling by including a higher dielectric constant material such as titanium dioxide.

Whilst the embodiment of the lighting tile 50 shown in FIG. 1 incorporates only two metallic strips, a larger number of strips or diametrically opposed conductive strips may be provided so that the capacitive coupling to a power source requires a progressively lowered degree of lateral or angular precision when positioning the lighting elements onto the supporting structure. An advantage of this is that a lower level of skill is then required to install the lighting element onto the supporting structure to achieve a desired resolution of connection.

FIG. 6 shows an arrangement where the lighting tile 70 include four conductive strips (55A, 55B, 56A, 56B). The spacing of the metallic strips is an integer fraction of the width of the conductive strips 24 on the supporting structure. This ensures that maximum power is transferred to the lighting element.

Referring to FIG. 7, a simplified circuit is shown to achieve the maximum power transfer in the case where there is four electrically conductive strips on the lighting element 70. The electrical outputs are combined via multiple groups of diodes 71 formed as bridge rectifiers (or equivalent rectification circuits). Constructive current summing is then achieved to feed LEDs 59.

In any of the above arrangements other numbers of LEDs can be used in a series or parallel connection. To illustrate the operation of a lighting tile 50 capacitively coupled to a power supply according to the invention it will be convenient to set out a worked example.

Referring to FIG. 8, a simplified circuit diagram of a lighting element including nine LEDs is shown capacitively coupled to an AC power supply. It will be convenient to illustrate how to determine approximately what frequency of power supply will satisfactorily illuminate the LEDs.

The impedance of a capacitor is given by the following equation:

$$Z = \frac{1}{2 π f C}$$

Where f is the frequency of the power supply and C is the capacitance of the capacitor.

Furthermore, the impedance of a capacitor may also be determined by the following equation:

$$Z = \frac{V}{I}$$

Where V is the voltage drop across the capacitor and I is the current flowing through it.

Combining the above two equations to solve f gives:

$$f = \frac{I}{V2 π C}$$

It is necessary to determine the capacitance of both CA and CB, these being capacitances provided by the arrangements of electrically conductive plates. The capacitance of two parallel plates is calculated as follows:

$$C = \frac{k o A}{d}$$

Where:

k is the dielectric constant of the material between the plates of the capacitor. For the purpose of this example k will be taken to be 6.

εo is the permeability of a vacuum, which is 8.9×10⁴² c²/Nm².

A is the area of the plates. For the purpose of this example the dimensions of each plate are 0.1 m×0.05 m Thus producing an area of 0.005 m²

d is the distance between the plates. For this example d is 0.05 mm or 0.00005 m.

$$\begin{matrix}Therefore , the capacitance of each of {C}_{A } and {C}_{B} = \frac{6 \times 8.9 \times {10}^{- 12} \times 0.005}{0.00005} \\ = 5.3 \times {10}^{- 9} F \\ = 5.3 nF\end{matrix}$$

Diodes and LEDs conduct electricity non-linearly and will also have varying characteristics, consequently the following is a simplified calculation to illustrate the approximate magnitudes of parameters. For normal operation of the LEDs of FIG. 9 the voltage drop VAB will be 1.5 volts for diodes 67 plus 3.5 volts each for LEDs 59. Total voltage drop VAB will be 33 volts and an average current of 20 mA will flow through the LEDs. Thus, when using a 48 volt power supply, the voltage drop across each capacitor in FIG. 8 is given by:

$$\frac{( 48 - 33 )}{2} = 7.5 volts$$

Thus, substituting the known values of current, voltage and capacitance into the equation derived above for solving f we arrive at:

$$f = \frac{0.02}{7.5 \times 2 \times π 5.3 \times {10}^{- 9}} = 80 kHz$$

Thus, a 48 Volt AC power supply of 80 kHz will satisfactorily illuminate the LED's of FIG. 8.

Perceived light output intensity may be increased by using microcontroller 61 to pulse larger current through the LEDs 59 whilst maintaining the same average current drain.

The capabilities of the capacitive coupling may be improved by increasing the capacitances of the capacitors formed in the coupling. This may be achieved by utilising a dielectric material with a higher dielectric constant in the insulating layer. In addition, the elements of the capacitors may be positioned closer together. Thirdly, the coupled capacitive surface area may be increased using complex surface area techniques without increasing the overall tile dimensions. Fourthly, the AC frequency of the power supply may be increased.

As mentioned above, the lighting element may include sensors 60, and a microcontroller 61 to accept and receive signals and to provide control over the LEDs.

With reference to FIG. 9, the light tile circuitry is structured so that all data is transferred by the same electrical path that is used for the electrical power transfer, that is via the two capacitors formed when the tile is in intimate contact with the supporting structure. With this arrangement, data is superpositioned on the primary power.

Each light tile 50 is able to transmit data under control of the microcontroller 61 through the data modulator 80 transmitted over the electrical path and extracted on another tile or device via a data demodulator 81. A clock recovery circuitry 82 is also included within the lighting element 50 to recover a clock of identical frequency to the primary power. Systemwide synchronous data transmission is then facilitated by this clock.

FIG. 10 illustrates the light tiles connected in a local network. As can be seen the power supply 11 incorporates a modulator and demodulator circuit 83 to allow external data networks or external control to communicate with the light tile network. The power supply is supplied by a circuit element that presents a low impedance to the primary power but a high impedance to the data modulation signal. This thereby minimises the attenuation by the power supply of the superimposed data signals.

In operation, the lighting system enables all data to be broadcast over the whole light tile system. The data communication protocol used is a peer to peer protocol. Each light tile is given a unique address at its time of manufacture and this address is stored in a non volatile memory. To initialise the system, a central controller may be required to allocate dynamic and semi-permanent address allocation for use during operation as required by the system. For example, this would allow particular light tiles to be logically grouped for example to allow a number of units to be controlled by a single message.

Once the system is fully initialised with the central controller, that controller is no longer required to enable communication between light tiles and/or the power supply and external systems. For a message to be successfully delivered, only one device is permitted to transmit at any time. Further, all devices can receive at all times and will only act upon messages addressed to that device. Message collisions are managed by the control device using multiple repeat, acknowledge or random time to retry methods as necessary. The data structure implemented is one of multi-byte data packet supported by a two-byte cyclic redundancy check sum to detect data errors. Additional parity checking may also be used.

In operation of the lighting system 10 an energised surface is created by virtue of the surface coating 22 connected to the power supply 11. The lighting tile element 50 can then be affixed and capacitively coupled to the energised surface with a large degree of flexibility of location. Further, these tiles can be removed without marking the energised surface in view of the magnetic attraction and capacitive coupling which is used to connect the light tile to the light network and support that tile against the supporting structure. In view of the control functionality, and sensors embedded within the lighting tile, data is able to be transmitted between the light tile enabling a broad range of control functions to be implemented on that tile.

Finally, it is to be understood that alterations, modifications and/or additions may be introduced into the constructions and arrangements of parts previously described without departing from the spirit or ambit of the invention.

1. A system for connecting an electrical device to a power source, the system providing for an electrical coupling between the electrical device and an energised surface associated with the power source and comprising:
at least two conductive elements disposed at or adjacent an exterior surface of the electrical device, and
a supporting surface including an array of conductive elements connectable to the power source to form the energised surface,
wherein the array of conductive elements and the supporting surface are arranged such that, when the electrical device is contacted with the energised surface in any one of a plurality of selected positions, the conductive elements of the electrical device make a capacitive coupling with some of the conductive elements located on the supporting surface so as to couple capacitively the electrical device to the power source.

2. A lighting system comprising a lighting element and a support surface, the lighting element comprising a generally thin body having opposite first and second major surfaces, at least one lighting source mounted to the body and operative to emit light, and at least two conductive elements disposed at or adjacent to the second major surface, the supporting surface including an array of electrically conductive elements which are connectable to a power source so as to provide an energised surface, wherein the lighting element is able to be disposed in any one of a plurality of selected positions on the energised surface where at least two of the conductive elements of the supporting surface form a capacitive coupling with the at least two conductive elements of the lighting element so as to connect the lighting element to the power source.

3. The system as claimed in claim 1 or 2 wherein an electrical insulating layer is disposed between the conductive elements of the electrical device or the lighting element and the array of conductive elements of the supporting surface.

4. The system as claimed in claim 3 wherein the electrically insulating layer is provided as an insulating overlay on the exterior surface of the electrical device or the lighting element.

5. The system as claimed in claim 3 wherein the insulating layer is provided as an insulating overlay disposed on the energised surface.

6. The system as claimed in claim 3 wherein the insulating layer is provided as an insulating overlay on both the exterior surface of the electrical device or the lighting element and the energised surface.

7. The system as claimed in claim 5 or 6 wherein the array of electrically conductive elements is mounted on a backing sheet which forms at least part of the insulating layer between the conductive elements of the electrical device or the lighting element and the array of conductive elements of the supporting surface.

8. The system as claimed in claim 7 wherein the backing sheet includes a polymer sheet and wherein the array of electrical conductive elements is formed by metallised strips applied to the sheet.

9. The system as claimed in claim 7 wherein the backing sheet comprises a paper sheet and wherein the array of electrical conductive elements is formed by metallised strips applied to the sheet.

10. The system as claimed in any one of the preceding claims further comprising fixing means operative to releasably mount the electrical device or the lighting element on the energised surface.

11. The system as claimed in any one of the preceding claims wherein the electrical device or the lighting element is securable to the supporting surface by a magnetic force exerted between a magnetisable material located on or in the supporting surface and a magnetisable material located on or in the electrical device or the lighting element.

12. The system as claimed in any one of the preceding claims further comprising a controller associated with the electrical device or the lighting element and operative to control a function of the electrical device or the lighting element in response to a received data signal, and wherein the data signal is operative to be transmitted to the electrical device or the lighting element via the electrical connection connecting the electrical device or the lighting element to the power source.

13. The system as claimed in any one of the preceding claims further comprising a sensor operative to receive information, and a processor which is operative to generate and transmit a data signal in response to the received information, wherein the sensor and the processor are associated with the electrical device or the lighting element and the data signal is transmitted by the processor via the electrical connection connecting the electrical device or the lighting element to the power source.

14. The system as claimed in claim 1 wherein the electrical device is a lighting element.

15. A lighting element suitable for connection to a power source using the system as claimed in claim 1 or any one of claims 2 to 13 when dependent on claim 1, the lighting element comprising a body having opposite first and second major surfaces, at least one light source mounted to the body to emit light and at least two conductive elements disposed at or adjacent to one of the surfaces arranged to form a capacitive coupling with an energised surface.

16. The lighting element as claimed in claim 15 wherein the light source is embedded within the element body between the opposite major surfaces.

17. The lighting element as claimed in claim 15 or 16 wherein the body is formed from a laminated structure and wherein the rearmost layer includes metallised strips which form the at least two conductive elements.

18. The lighting element as claimed in any one of claims 15 to 17 wherein the at least one light source is a light emitting diode (LED).

19. The lighting element as claimed in any one of claims 15 to 17 wherein the at least one light source is an organic light emitting diode (OLED) material.

20. The lighting element as claimed in claim in any one of claims 15 to 19 further comprising a controller operative to control a function of the lighting element in response to a received data signal.

21. The lighting element as claimed in any one of claims 15 to 20 further comprising a sensor operative to receive information, and a processor which is operative to generate and transmit a data signal in response to the received information.

22. The lighting element as claimed in any one of claims 15 to 21 wherein the body also comprises a printed circuit board sub-assembly which provides mechanical support for circuitry and electrical components of the lighting element.

23. The lighting element as claimed in any one of claims 15 to 22 further comprising a magnetisable material so as to enable the lighting element to be secured to a supporting surface with suitable magnetic properties by a magnetic force.

24. The lighting element as claimed in any one of claims 15 to 23 wherein the body further comprises a front cover which forms the first major surface and which has optical characteristics to assist in light emission from the lighting element.
